(19) United States
(12) Patent Application Publication
(10) Pub. No.: US 2003/0083047 A1
(43) Pub. Date: May 1, 2003

(54) Method and communication network for providing operating information associated with a wireless device

(76) Inventors: Garland Phillips, Arlington, TX (US); Soeren H. Thomsen, N Richland Hills, TX (US); Kevin C. Mowry, Irving, TX (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/055,194

(22) Filed: Oct. 29, 2001

(51) Int. Cl. H04M 11/10

(52) U.S. Cl. 455/412; 455/466

(57) ABSTRACT

In accordance with the preferred embodiments of the present invention, a method and a communication network for providing operating information associated with a wireless device to a device participating in real-time communication with the wireless device. The communication network (110) provides real-time communication service such as instant messaging service and group chat service to a first device and a second device. The first device (160) may be a wireless device such as a cellular telephone, a pager, and an electronic planner. The communication network (110) receives operating information associated with the first device (160) and transmits the operating information to a second device (240). The second device (240) may generate an indication such as an icon, a graphic image, a textual message, and an audio message based on the operating information associated with the first device (160).

### FIELD OF THE INVENTION

The present invention relates generally to wireless communication systems, and more particularly, to a method and an apparatus for providing operating information associated with a wireless device to a device participating in real-time communication with the wireless device.

### BACKGROUND OF THE INVENTION

A wireless communication system is a complex network of systems and elements. Typically elements include (1) a radio link to the mobile stations (e.g., cellular telephones), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a call controller (e.g., a mobile switching center (MSC)) or switch, typically a call agent (i.e., a “softswitch”), for routing calls within the system, and (5) a link to the land line or public switch telephone network (PSTN), which is usually also provided by the call agent.

For many people, the Internet has provided alternative ways of communication. In particular, electronic mail messages (i.e., e-mail) have replaced traditional letters and sometimes voice calls as a way of communicating. However, e-mail may not provide a response fast enough in certain circumstances. Further, multiple exchanges of e-mails may require a number of steps to read, reply, and send the e-mails back and forth. Accordingly, real-time communication service such as instant messaging (IM) service and group chat service is becoming a communication mechanism to substitute for e-mail. For example, instant messaging service permits a subscriber to determine whether other subscribers such as friends or co-workers are on-line, and if so, to communicate with each other in “real time” over the Internet. Under most circumstances, real-time communication is “instant.” Even during peak traffic periods of the Internet, delay of real-time communication is typically less than a few seconds. Thus, subscribers may have a real-time on-line “conversation” by exchanging messages with each other (i.e., sending messages back and forth). For example, parents may be able to “talk” with their children who are attending college or working in other cities, states, or countries via real-time communication service. As a result, real-time communication service may even replace voice calls because of cost and convenience.

One aspect of designing a wireless communication system is to provide real-time communication service to mobile stations, i.e., wireless devices such as cellular telephones, pagers, and electronic planners. However, wireless devices have resource limitations that may not apply to wired devices such as desktop computers. Thus, such limitations are unknown to users of the wired devices. In particular, wireless devices may have limitations including bandwidth, display capability, input capability, link cost, link type, latency and power constraints. For example, communication between a wireless device and a wired device may experience a longer delay than that between two wired devices because of the inherent nature of wireless communication systems (i.e., queuing delay, transmission time, and network congestion). In another example, a wireless device may be limited to exchanging text-only messages because the network providing the link for real-time communication to the wireless device may not be able to support exchange of attachments.

Further, wireless devices may experience changes in status that are not normally experienced by wired devices. These status changes may affect the ability or the availability of a wireless device user to participate in real-time communication. For example, a real-time message sent by a wired device to a wireless device may be queued because the wireless device is unable to receive the message while being in an elevator or a subway system. Accordingly, the wireless device user may not be able to respond immediately to the message sent from the wired device user. As a result, the wired device user does not know why the wireless device user did not respond to the message.

Therefore, a need exists for a communication network and a method to provide operating information associated with a wireless device to other subscribers of real-time communication service.

### BRIEF DESCRIPTION OF THE DRAWINGS

FIG. 1 is a block diagram representation of a wireless communication system that may be adapted to operate in accordance with the preferred embodiments of the present invention.

FIG. 2 is a block diagram representation of a communication network that may be adapted to operate in accordance with the preferred embodiments of the present invention.

FIG. 3 is a visual representation of operating information that may be generated in accordance with the preferred embodiments of the present invention.

FIG. 4 is a flow diagram representation of a method for providing operating information associated with a wireless device in accordance with the preferred embodiments of the present invention.

### DETAIL DESCRIPTION OF THE PREFERRED EMBODIMENTS

The present invention provides a method and a communication network for providing operating information associated with a wireless device to another subscriber of real-time communication service in a communication system. The communication system provides real-time communication service such as instant messaging service and group chat service to a plurality of subscribers. In particular, a first subscriber operating a first device is in real-time communication with a second subscriber operating a second device. The communication network receives operating information associated with the first device, which may be a wireless device. The operating information may be, but is not limited to, status information and resource information associated with the first device. For example, resource information may be information associated with one of bandwidth, display capability, input capability, link type, link cost, device type, link or communication latency and power of the first device. Accordingly, the communication network transmits the operating information to the second device. In response to receipt of the operating information from the communication network, the second device may generate an indication such as an icon, a graphic image, a textual message, and/or an audio message to provide the second subscriber with operating information associated with the first device.

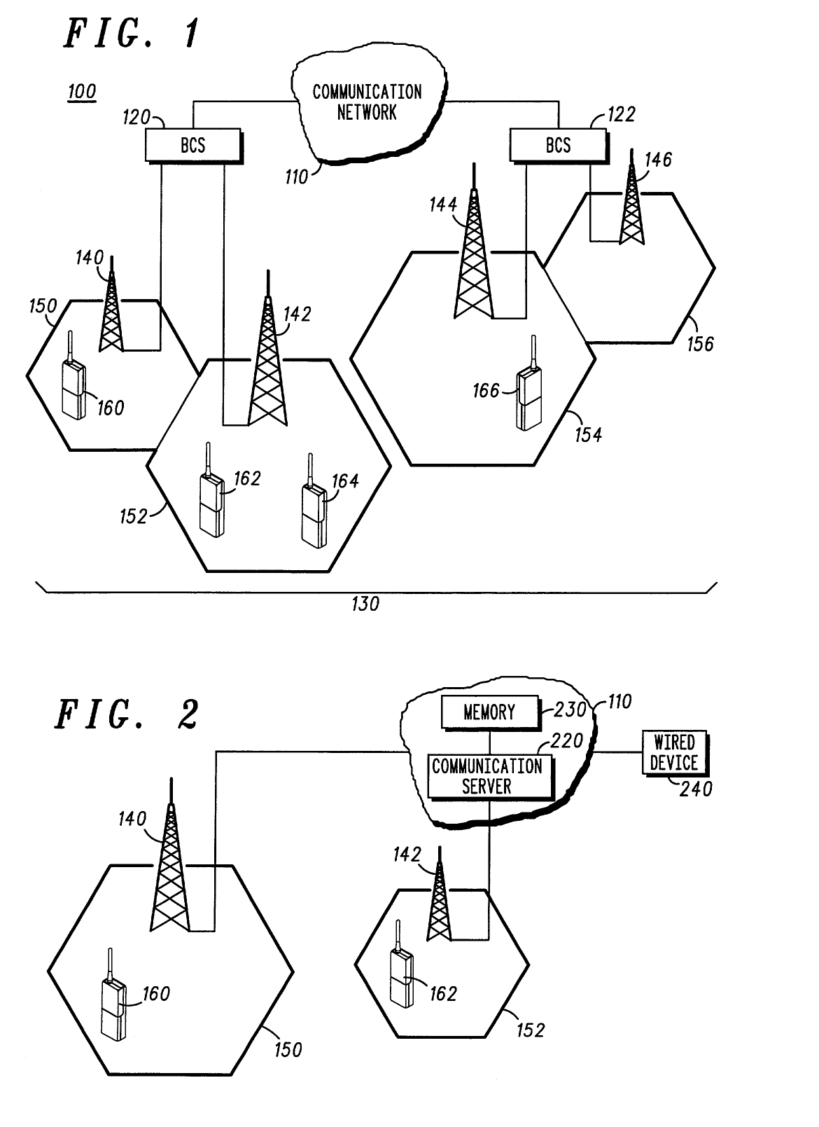

The communication system in accordance with the present invention is described in terms of several preferred embodiments, and particularly, in terms of a wireless communication system operating in accordance with at least one of several communication standards. These standards include analog, digital or dual-mode communication system protocols such as, but not limited to, the Advanced Mobile Phone System (AMPS), the Narrowband Advanced Mobile Phone System (NAMPS), the Global System for Mobile Communication (GSM), the IS-55 Time Division Multiple Access (TDMA) digital cellular, the IS-95 Code Division Multiple Access (CDMA) digital cellular, CDMA 2000, the Personal Communications System (PCS), 3G and variations and evolutions of these protocols. As shown in FIG. 1, a wireless communication system 100 includes a communication network 110, a plurality of base station controllers (BSC), generally shown as 120 and 122, servicing a total service area 130. The wireless communication system 100 may be, but is not limited to, a frequency division multiple access (FDMA) based communication system, a time division multiple access (TDMA) base communication system, and a code division multiple access (CDMA) based communication system. As is known for such systems, each BSC 120 and 122 has associated therewith a plurality of base stations (BS), generally shown as 140, 142, 144, and 146, servicing communication cells, generally shown as 150, 152, 154, and 156, within the total servicing area 130. The BSCs 120 and 122, and BSs 140, 142, 144, and 146 are specified and operate in accordance with the applicable standard or standards for providing wireless communication services to mobile stations (MS), generally shown as 160, 162, 164, and 166, operating in communication cells 150, 152, 154, and 156, and each of these elements are commercially available from Motorola, Inc. of Schaumburg, Ill..

Referring to FIG. 2, the communication network 110 generally includes a communication server 220 and a memory 230. The communication network 110 may be, but is not limited to, an Internet Protocol (IP) network. The communication server 220 may be, but is not limited to, a server operable to provide instant messaging service and a server operable to provide group chat service. In particular, the communication server 220 provides exchange of, but not limited to, text-only messages between a plurality of subscribers. The communication server 220 is operatively coupled to the memory 230, which is operable to store a “buddy” list or a contact list that includes information associated with subscribers of real-time communication service such that a particular subscriber may be able to interact with those subscribers on the list. In addition, the memory stores a program or a set of operating instructions. Accordingly, the server 220 executes the program or the set of operating instructions such that the communication network 110 operates in accordance with a preferred embodiment of the invention. The program or the set of operating instructions may be embodied in a computer-readable medium such as, but not limited to, paper, a programmable gate array, application specific integrated circuit, erasable programmable read only memory, read only memory, random access memory, magnetic media, and optical media. Further, the communication network 110 is coupled for communication with a first device and a second device. The first device may be a wireless electronic device such as, but not limited to, a cellular telephone (e.g., mobile station 160 and mobile station 162), a pager, and an electronic planner. The second device may be either a wireless electronic device such as mobile station 162 or a wired device 240 such as, but not limited to, a desktop computer and a laptop computer.

A basic flow for providing operating information associated with a wireless device that may be applied with the preferred embodiment of the present invention shown in FIG. 2 may start with a first device and a second device participating in real-time communication such as instant messaging and group chat. In particular, the communication network 110 provides instant messaging service to the mobile station 160 (i.e., the first device) and the wired device 240 (i.e., the second device). The communication server 220 receives operating information associated with the mobile station 160 in response to a trigger event such as, but not limited to, a registration, a subscriber input, and a change in status. The operating information may be, but is not limited to, resource information and status information associated with the mobile station 160. For example, the communication server 220 may receive operating information associated with the mobile station 160 in response to the mobile station 160 registering for real-time communication service. The registration may include resource information associated with the mobile station 160. Further, the communication server 220 may receive status information associated with the mobile station 160 in response to a subscriber input (e.g., pressing of keys by the subscriber operating the mobile station 160) or a change in status of the mobile station 160 (e.g., location, operational environment, or operating mode of the mobile station 160).

The resource information may be, but is not limited to, information of bandwidth, display capability, input capability, link type, link cost, device type, latency and/or power associated with the mobile station 160. In particular, bandwidth includes, but is not limited to, low-speed, medium-speed, and high-speed connection of the mobile station 160 to the communication network 110. Display capability refers to, but not limited to, screen size and format of the display on the mobile station 160 (e.g., text-only, color, monochrome and graphics). Input capability includes input via, but not limited to, a numeric keypad, an alphanumeric keypad, and a touch-sensitive display. Link type includes, but is not limited to, packet data network and circuit switched network (e.g., public switching telephone network (PSTN)). Link cost refers to the cost per minute or the cost per character for the link, e.g., the mobile station's link to a packet data network. The type of device includes, but is not limited to, a cellular telephone, a pager, and an electronic planner. For example, the communication server 220 may receive operating information that indicates the mobile station 160 is a cellular telephone. Latency refers to the delay for the mobile station 160 to transmit and to receive a message because of the inherent nature of the wireless communication system 100 as shown in FIG. 1 (i.e., queuing delay, transmission time, and network congestion).

The status information may be, but is not limited to, information associated with location and operating mode of the mobile station 160. For example, the communication server 220 may receive information that indicates the mobile station 160 is outside of a coverage area where instant messaging service is provided. Further, the communication server 220 may receive information associated with location that indicates the mobile station 160 is at home, at the office, at the airport, etc. Operating mode includes, but is not limited to, active, inactive, private and voice call mode. For example, the mobile station 160 may be in the private mode during a meeting when the user of the mobile station 160 simply wants to be a passive participant in the real-time communication (i.e., without contributing to the exchange of messages).

In response to receipt of the operating information from the mobile station 160, the communication server 220 transmits the operating information to the wired device 240 such as a desktop computer. The wired device 240 may generate an indication such as, but not limited to, an icon, a graphic image, a textual message, and/or an audio message based on the operating information as further described in detail below. For example, the wired device 240 may generate an icon of a cellular telephone to indicate that the mobile station 160 is a cellular telephone. In another example, the wired device 240 may generate a textual message to indicate that the mobile station 160 is inactive, i.e., the mobile station 160 is turned off.

In an alternate embodiment, the communication network 110 may provide real-time communication service to at least two wireless devices. For example, the communication network 110 may provide instant messaging service to the mobile station 160 and the mobile station 162. Accordingly, the communication server 220 receives operating information from the mobile station 160 and transmits the operating information to the mobile station 162. Further, the communication server 220 may be adapted to provide the operating information to devices used by other subscribers of instant messaging service who are included on the “buddy” list stored in the memory 230. For example, the “buddy” list may include friends of a subscriber.

In another alternate embodiment, the communication network 110 may provide group chat service to the mobile station 160, the mobile station 162, and the wired device 240. As a result, the communication server 220 receives the operating information from the mobile station 160 and transmits the operating information to the mobile station 162 and the wired device 240. The communication server 220 may be adapted to provide the operating information to devices used by other subscribers of group chat service who are included on the “buddy” list stored in the memory 230. For example, the “buddy” list may include co-workers of a subscriber.

As shown in FIG. 3, a display 310 of a device participating in real-time communication with a wireless device (e.g., the mobile station 162 and the wired device 240 shown in FIG. 2) is adapted in accordance with a preferred embodiment of the invention to provide operating information of the wireless device (e.g., the mobile station 160 shown in FIG. 2) to another subscriber of real-time communication service. In particular, a first subscriber (Subscriber #1) and a second subscriber (Subscriber #2) are operating a first device and a second device, respectively, such that the first and second devices are in real-time communication with each other. The operating information such as resource information and status information associated with the first device is provided to the second device. In response to receipt of the operating information, the display 310 of the second device generates an indication such as, but not limited to, an icon, a graphic image, a textual message and an audio message based on the operating information. For example, an icon of a cellular telephone 312 may be generated on the display 310 to indicate the type of wireless device operated (i.e., the first device) by the first subscriber. Accordingly, an icon of a pager 314 and an icon of an electronic planner 316 indicate that the wireless device is a pager and an electronic planner, respectively. In another example, the operating information may provide information associated with the type to link of the wireless device. In particular, an icon of a thin double-arrow line 322 indicates a slow wireless link (e.g., a link via paging) between the first device and the second device whereas an icon of a medium-sized double arrow line 324 indicates a faster wireless link and an icon of a thick double-arrow line 326 indicates the fastest wireless link (e.g., a cable modem link) available to the first device. The operating information may also provide information associated with link cost of the wireless device 160 (e.g., cost per character, cost per minute, etc.) For example, an icon of four “$” 332 may indicate that the cost for the first device to be connected for real-time communication is very high whereas one “$” may indicate that the cost is low. Further, power of the first device may be indicated by an icon of a battery 342 and icon of a plug 344. For example, the icon of a battery 342 may indicate the first device is using a battery and the amount of power left in the battery, whereas the icon of a plug 344 indicates the first device is charging (i.e., on a charger) or the power source is AC power.

As noted above, the operating information may be status information associated with the first device. In particular, status information may be, but is not limited to, location and operating mode of the first device. For example, the location of the first device may be indicated by a text message 352 such as “Subscriber #1 is home” generated on the display 310. Other locations of the first device may be, but are not limited to, at the office, at the airport, etc. Further, the communication network 110 as shown in FIG. 2 may provide operating information associated with the first device to indicate that the first device has roamed to a coverage area of a carrier network or an analog network where real-time communication may be unavailable. Because of the unavailability of real-time communication where the first device is located, the communication network 110 may also provide operating information associated with the first device to indicate that messages are being queued until the first device is available for real-time communication. In another example, a text message 354 such as “Subscriber #1's cellular telephone is turned off” may be generated on the display 310 to indicate that the first device is inactive (i.e., an operating mode of the first device). Other operating modes may be, but are not limited to, active, private, and voice call modes. In particular, the first device does not alert the subscriber during the private mode. The private mode permits a subscriber to be a passive participant and simply view the exchange of messages without actively participating in the real-time communication. A textual message may be provided to the other subscribers so that they do not expect the subscriber operating the first device to participate in the real-time communication. In the voice call mode, a text message may be generated to indicate that the first device is on a voice call and the subscriber is unavailable for real-time communication.

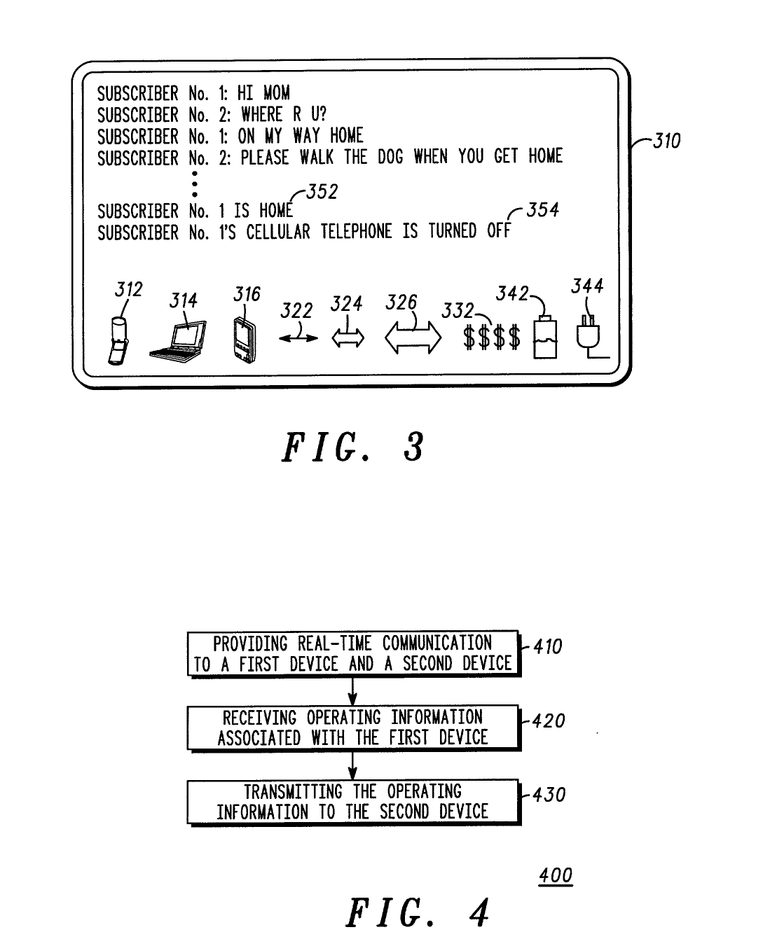

In accordance with the preferred embodiments of the present invention, and with references to FIG. 4, a method 400 for providing operating information associated with a wireless device to a device participating in real-time communication with the wireless device is shown. Method 400 begins at step 410, where a communication network provides real-time communication service to a first device operated by a first subscriber and a second device operated by a second subscriber. In particular, the real-time communication service may be, but is not limited to, instant messaging service and group chat service. The first device may be a wireless device such as, but not limited to, a cellular telephone, a pager, and an electronic planner. The second device may be either a wireless device or a wired device such as a desktop computer. At step 420, the communication network receives operating information associated with the first device. The operating information may be, but is not limited to, resource information and status information associated with the first device. In particular, the operating information may include information of bandwidth, display capability, input capability, link type, link cost, device type, latency, power, location and operating mode associated with the first device. For example, the input capability of the first device may be, but is not limited to, a numeric pad, an alphanumeric pad, and a touch-sensitive display. At step 430, the communication network transmits the operating information to the second device. In response to receipt of the operating information, the second device may generate an indication such as, but not limited to, an icon, a graphic image, a textual message, and an audio message based on the operating information. For example, the second device may generate an icon of a pager to indicate that the first subscriber is using a pager to participate in real-time communication with the second subscriber. As a result, the second subscriber may proceed accordingly based on the operating information (i.e., the first subscriber is using a pager) by providing the first subscriber with an abbreviated message rather than an elaborate message.

Many changes and modifications could be made to the invention without departing from the fair scope and spirit thereof. The scope of some changes is discussed above. The scope of others will become apparent from the appended claims.

What is claimed:

1. In a communication system, the communication system providing real-time communication service to a plurality of subscribers, wherein a first subscriber is in communication with a second subscriber, a method for providing operating information associated with a wireless device to the second subscriber comprising:
providing real-time communication service to a first device and a second device, the first device being a wireless device;
receiving operating information associated with the first device; and
transmitting the operating information to the second device.

2. The method of claim 1, wherein providing the real-time communication service to a first device and a second device comprises providing one of instant messaging service and group chat service to a first device and a second device.

3. The method of claim 1, wherein receiving operating information associated with the first device comprises receiving operating information associated with the first device in response to a trigger event, wherein the trigger event comprises one of a registration, a subscriber input and a change in status.

4. The method of claim 1, wherein receiving operating information associated with the first device comprises receiving one of status information and resource information associated with the first device.

5. The method of claim 1, wherein receiving operating information associated with the first device comprises receiving information associated with one of bandwidth, display capability, input capability, link type, link cost, device type, latency, power, location and operating mode of the first device.

6. The method of claim 1, wherein receiving operating information associated with the first device comprises receiving operating information associated with one of a cellular telephone, a pager, and an electronic planner.

7. The method of claim 1, wherein transmitting the operating information to the second device comprises transmitting the operating information to a device operable to generate one of an icon, a graphic image, a textual message, and an audio message based on the operating information.

8. The method of claim 1, wherein transmitting the operating information to second device comprises transmitting the operating information to one of a wireless electronic device and a wired electronic device.

9. In a communication system, the communication system providing real-time communication service to a plurality of subscribers, wherein a first subscriber is in communication with a second subscriber, and wherein a communication network is adapted to provide operating information associated with a wireless device to the second subscriber, the communication network comprising:
a memory;
a communication server coupled to the memory, the real-time communication server being operable to provide real-time communication service to a first device and a second device, the first device being a wireless device;
the communication server being operable to receive operating information associated with the first device, and
the communication server being operable to transmit the operating information to the second device.

10. The communication network of claim 9, wherein the communication server comprises a server being operable to provide one of instant messaging service and group chat service to a first device and a second device.

11. The communication network of claim 9, wherein the real-time communication server comprises a real-time communication server being operable to receive operating information associated with the first device in response to a trigger event, the trigger event being one of a registration, a subscriber input, and a change in status.

12. The communication network of claim 11, wherein the registration includes the operating information associated with the first device.

13. The communication network of claim 9, wherein the operating information associated with the first device comprises one of status information and resource information associated with the first device.

14. The communication network of claim 9, wherein the operating information comprises information associated with one of bandwidth, display capability, input capability, link type, link cost, device type, latency, power, location and operating mode of the first device.

15. The communication network of claim 9, wherein the operating information associated with the first device comprises operating information associated with of one of a cellular telephone, a pager, and an electronic planner.

16. The communication network of claim 9, wherein the communication network comprises an Internet Protocol (IP) network.

17. In a communication system, the communication system providing real-time communication service to a plurality of subscribers, wherein a first subscriber is in communication with a second subscriber, a method for providing operating information associated with a wireless device to the second subscriber comprising:
participating in real-time communication service with a first device, the first device being a wireless device;
receiving operating information associated with the first device; and
generating an indication based on the operating information associated with the first device.

18. The method of claim 17, wherein participating in real-time communication service with the first device comprises participating in one of instant messaging service and group chat service with the first device.

19. The method of claim 17, wherein receiving operating information associated with the first device comprises receiving information associated with one of bandwidth, display capability, input capability, link type, link cost, device type, latency, power, location and operating mode of the first device.

20. The method of claim 17, wherein receiving operating information associated with the first device comprises receiving operating information associated with one of a cellular telephone, a pager, and an electronic planner.

21. The method of claim 17, wherein generating an indication based on the operating information associated with the first device comprises generating an icon, a graphic image, a textual message, and an audio message based on the operating information.

22. In a communication system for providing real-time communication service to a plurality of subscribers, wherein a first subscriber is in communication with a second subscriber, and wherein a server operates in accordance to a computer program embodied on a computer-readable medium for providing operating information associated with a wireless device to the second subscriber, the computer program comprising:
a first routine that directs the server to provide real-time communication service to a first device and a second device, the first device being a wireless device;
a third routine that directs the server to receive operating information associated with the first device; and
a third routine that directs the server to transmit the operating information to the second device.

23. The computer program of claim 22, wherein the first routine comprises a routine that directs the server to provide one of instant messaging service and group chat service to a first device and a second device.

24. The computer program of claim 22, wherein the second routine comprises a routine that directs the server to receive operating information associated with the first device in response to a trigger event, the trigger event comprises one of a registration, a subscriber input and a change in status.

25. The computer program of claim 22, wherein the second routine comprises a routine that directs the server to receive one of status information and resource information associated with the first device.

26. The computer program of claim 22, wherein the second routine comprises a routine that directs the server to receive information associated with one of bandwidth, display capability, input capability, link type, link cost, device type, latency, power, location and operating mode of the first device.

27. The computer program of claim 22, wherein the second routine comprises a routine that directs the server to receive operating information associated with one of a cellular telephone, a pager, and an electronic planner.

28. The computer program of claim 22, wherein the third routine comprises a routine that directs the server to transmit the operating information to a device operable to generate one of an icon, a graphic image, a textual message, and an audio message based on the operating information.

29. The computer program of claim 22, wherein the third routine comprises a routine that directs the server to transmit the operating information to one of a wireless electronic device and a wired electronic device.

30. The computer program of claim 22, wherein the medium comprises one of paper, a programmable gate array, application specific integrated circuit, erasable programmable read only memory, read only memory, random access memory, magnetic media, and optical media.
